(19) United States
(12) Patent Application Publication
(10) Pub. No.: US 2024/0371105 A1
(43) Pub. Date: Nov. 7, 2024

(54) AUTOMATED ACCESS POINT INFORMATION PROCESSING WITH AUGMENTED REALITY FOR SIMPLIFIED COMMISSIONING

(71) Applicant: Haier US Appliance Solutions, Inc., Wilmington, DE (US)

(72) Inventors: Suzy Kwak, Seoul (KR); Hyeonsoo Moon, Seoul (KR); Han Young Kim, Gyeonggi-do (KR); Hang Il Ahn, Seoul (KR); Jaewon Jo, Gyeonggi-do (KR); Wee Dayeon, Gyeonggi-do (KR)

(21) Appl. No.: 18/310,174

(22) Filed: May 1, 2023

(51) Int. Cl. G06T 19/00; G06T 5/50; G06V 10/44; G06V 30/10

(52) U.S. Cl. CPC G06T 19/006; G06T 5/50; G06V 10/44; G06V 30/10; G06T 2207/20221; G06V 2201/07

(57) ABSTRACT

A method of commissioning a household appliance is provided. The method includes receiving an image of the household appliance, processing the image to determine the location of access point information, generating guidance to the location of the access point information, opening communication between the household appliance and a remote network using the access point information, and commissioning the household appliance to a user account.

### FIELD OF THE INVENTION

The present disclosure relates generally to household appliances which can connect to a home network or a remote network such as the internet. In particular, the present subject matter relates to a household appliance configured for improved commissioning of the household appliance to a user account and related methods.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances (i.e., smart appliances) can also include features for connecting to and communicating over a secure wireless network. Such communication may provide connected features on the household appliances, for example the household appliance may be configured to communicate with a personal device, smart home systems, and/or a remote database such as a cloud server. Some cloud servers may provide appliance monitoring to detect operational parameters, initiate maintenance procedures, or may be able to provide software updates to enhance features and operability. In order to establish secure communication, either directly with the network or through existing linked appliances, a commissioning procedure is required wherein an identification and password associated with the specific appliance must be provided to the network for the initial connection.

Typically, this information is provided on the appliance for the user to submit to the network. In some cases, the location of the information on the appliance to be commissioned is not obvious to the user. User difficulties in locating the information for commissioning may decreases the commissioning rate and lead to user dissatisfaction.

Accordingly, a need exists to facilitate user access to commissioning information on a household appliance.

### BRIEF DESCRIPTION OF THE INVENTION

Aspects and advantages of the invention will be set forth in part in the following description, may be apparent from the description, or may be learned through practice of the invention.

In one exemplary aspect, a method of commissioning a household appliance is provided. The method comprises the steps of receiving an image of the household appliance from an external device; determining the location of the access point information based on the processing of the image; generating guidance to the location of the access point information, wherein the guidance includes visual instructions provided on a display; opening communication between the household appliance and the remote network using the access point information; and commissioning the household appliance to a user account on the remote network.

In another example aspect, a method of commissioning a household appliance is provided. The method includes receiving a first image of the household appliance; processing the first image of the household appliance, the processing including extracting one or more identifying features of the household appliance to facilitate identification of the household appliance period the location of access point information is determined based on the identification of the household appliance in the first image period guidance is generated to the location of the access point information, wherein the guidance includes visual instructions provided on a display. The method continues with receiving a second image, the second image including access point information. The second image is processed, and graphical characters are detected using optical character recognition, in the processed second image, the graphical characters corresponding to a network identification and password. The network identification and password are recognized using optical character recognition and the network identification and password are received at a remote network. The recognized network identification and password are used to open communication between the household appliance and the remote network and the household appliance is commissioned to a user account on the remote network.

In another example aspect, a method of commissioning a household appliance is provided, the method comprising capturing an image of the appliance using an external device; transmitting the image of the appliance from the external device to a network; receiving guidance from the network to a location of an access point information; capturing an image of the access point information at the location of the access point information; and transmitting the image of the access point information to the network.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a household appliance in accordance with an embodiment of the present disclosure;

FIG. 2 is a captured image of the household appliance of FIG. 1;

FIG. 3 represents a first guidance image in accordance with an embodiment of the present disclosure;

FIG. 4 represents a second guidance image in accordance with an embodiment of the present disclosure;

FIG. 5 represents a third guidance image in accordance with an embodiment of the present disclosure;

FIG. 6 represents a captured image of access point information in accordance with an embodiment of the present disclosure;

FIG. 7 represents an optical character recognition analysis of the access point information entered in data fields in accordance with an embodiment of the present disclosure; and

FIG. 8 is a flow chart representing a method of operation for automated access point processing in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

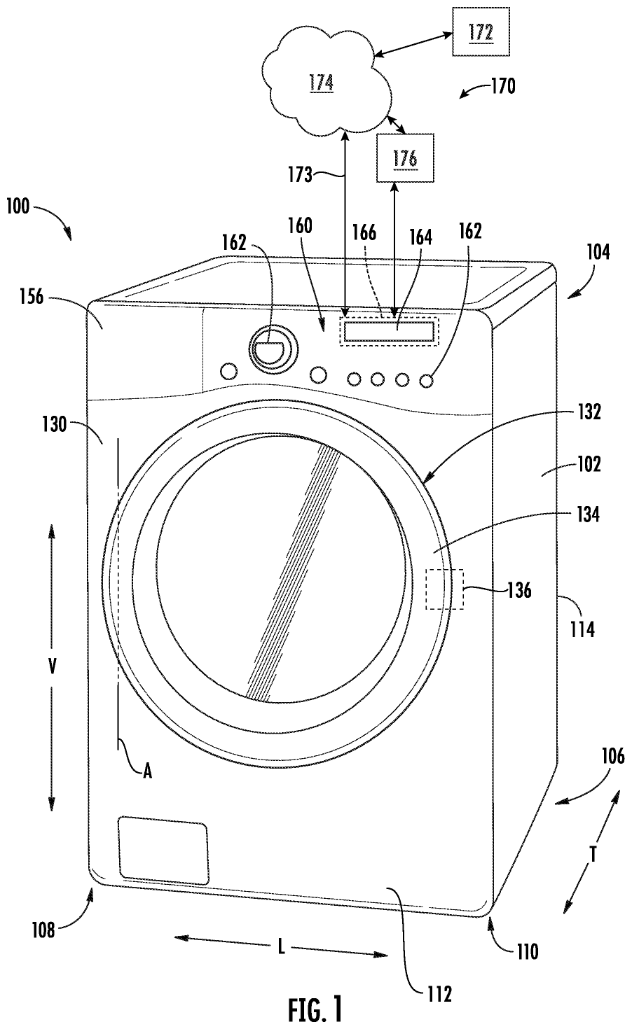

Turning to the figures, FIG. 1 provides a perspective view of a household appliance 100 in accordance with one or more embodiments of the present disclosure. The household appliance 100 is generally illustrated to be a horizontal axis (i.e., front loading) washing machine for convenience only. It should be understood that “household appliances” or “appliances” are used herein to describe appliances typically used or intended for common domestic tasks, such as laundry appliances or kitchen appliances, for example air conditioners, dishwashing appliances, water heaters, etc., and any other household appliance which performs similar functions in addition to network communication and data processing.

As one of ordinary skill in the art will recognize, the features and benefits disclosed herein will apply as well to household appliances other than the illustrated washing machine, such as refrigerators, dishwashers, microwaves, coffee makers, as well as other laundry appliances, for example clothes dryers. Reference to household appliances throughout this specification will be generally understood to apply to any appliance typically found in a household setting.

As illustrated, household appliance 100 generally includes a cabinet 102 which defines a vertical direction V, a horizontal direction H, and a transverse direction T that are mutually perpendicular. The cabinet 102 extends from a top 104 to a bottom 106 along the vertical direction V, between a first or left side 108 and a second or right side 110 along the lateral direction L, and between a front 112 and a rear 114 along the transverse direction T.

The cabinet 102 also includes a front panel 130 which defines an opening 132 that permits user access to an interior of the cabinet (not shown). More specifically, household appliance 100 includes a door 134 that is positioned over opening 132 and is rotatably mounted to front panel 130 for rotation about generally vertical axis A. In this manner, door 134 permits selective access to opening 132 by being movable between an open position (not shown) facilitating access to the tub and a closed position (FIG. 1) prohibiting access to the tub. Household appliance 100 may further include a latch assembly 136 that is mounted to cabinet 102 or door 134 for selectively locking door 134 in the closed position.

Household appliance 100 may also include a control panel 160 that may represent a general-purpose Input/Output (“GPIO”) device or functional block for household appliance 100. In some embodiments, control panel 160 may include or be in operative communication with a plurality of input selectors 162 is coupled to front panel 130, such as one or more of a variety of digital, analog, electrical, mechanical, or electro-mechanical input devices including rotary dials, control knobs, push buttons, toggle switches, selector switches, and touch pads. Control panel 160 and input selectors 162 collectively form a user interface input for operator selection of machine cycles and features. For example, in one embodiment, a display 164 may be provided on the control panel 160 and include one or more status lights, screens, or visible indicators to indicate selected features, instructions, figures, diagrams, or other items of interest to machine users. According to exemplary embodiments, user input selectors 162 and display 164 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Household appliance 100 may further include or be in operative communication with a processing device or a controller 166 that may be generally configured to facilitate appliance operation. In this regard, control panel 160, user input devices 162, and display 164 may be in communication with controller 166 such that controller 166 may receive control inputs from user input devices 162, may display information using display 164, and may otherwise regulate operation of appliance 100. For example, signals generated by controller 166 may operate appliance 100, including any or all system components, subsystems, or interconnected devices, in response to the position of user input devices 162 and other control commands. Control panel 160 and other components of appliance 100 may be in communication with controller 166 via, for example, one or more signal lines or shared communication busses. In this manner, Input/Output (“I/O”) signals may be routed between controller 166 and various operational components of appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 166 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 166 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 166 may be operable to execute programming instructions or micro-control code associated with an operating cycle of appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 166 as disclosed herein is capable of and may be operable to perform any methods, method steps, or portions of methods as disclosed herein. For example, in some embodiments, methods disclosed herein may be embodied in programming instructions stored in the memory and executed by controller 166.

The memory devices may also store data that can be retrieved, manipulated, created, or stored by the one or more processors or portions of controller 166. The data can include, for instance, data to facilitate performance of methods described herein. The data can be stored locally (e.g., on controller 166) in one or more databases and/or may be split up so that the data is stored in multiple locations. In addition, or alternatively, the one or more database(s) can be connected to controller 166 through any suitable network(s), such as through a high bandwidth local area network (LAN) or wide area network (WAN), for example a network in a user's home. In this regard, for example, controller 166 may further include a communication module or interface that may be used to communicate with one or more other component(s) of appliance 100, controller 166, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring still to FIG. 1, a schematic diagram of an external communication system 170 will be described according to an exemplary embodiment of the present subject matter. In general, external communication system 170 is configured for permitting interaction, data transfer, and other communications between appliance 100, particularly controller 166, and one or more external devices. For example, this communication may be used to provide and receive operating parameters, user instructions or notifications, performance characteristics, user preferences, or any other suitable information for improved performance of appliance 100. In addition, it should be appreciated that external communication system 170 may be used to transfer data or other information to improve performance of one or more external devices or appliances and/or improve user interaction with such devices.

For example, external communication system 170 permits controller 166 of appliance 100 to communicate with a separate device external to appliance 100, referred to generally herein as an external device 172. As described in more detail below, these communications may be facilitated using a wireless connection, such as via a network 174. In general, external device 172 may be any suitable device separate from appliance 100 that is configured to provide and/or receive communications, information, still images, video, data, or commands to or from a user. In this regard, external device 172 may be, for example, a personal phone, a smartphone, a tablet, a laptop or personal computer, a wearable device, a smart home system, or another mobile or remote device capable of image capture, receipt, and transfer.

In addition, a remote server 176 may be in communication with appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control appliance 100, etc. In addition, external device 172 and remote server 176 may communicate with appliance 100 to communicate similar information.

In general, communication between appliance 100, external device 172, remote server 176, and/or other user devices or appliances may be carried using any type of wireless connection and using any suitable type of communication network, non-limiting examples of which are provided below. For example, external device 172 may be in direct or indirect communication with appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc., for example a network in the user's home and linked to the network 174. In addition, communications may be transmitted using any suitable communications devices or protocols, such as via Wi-Fi®, Bluetooth®, Zigbee®, wireless radio, laser, infrared, Ethernet type devices and interfaces, etc. suitable for such a home network. In addition, such communication may use a variety of communication protocols (e.g., TCP/IP. HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Methods and systems according to the present disclosure advantageously provide a more convenient user experience when commissioning a new household appliance 100. For example, commissioning the appliance 100 may include connecting the appliance(s) to a WI-FI® network, for example in the user's home, for the first time and adding the appliance to a user account on the remote network 174 through a secure network connection 173.

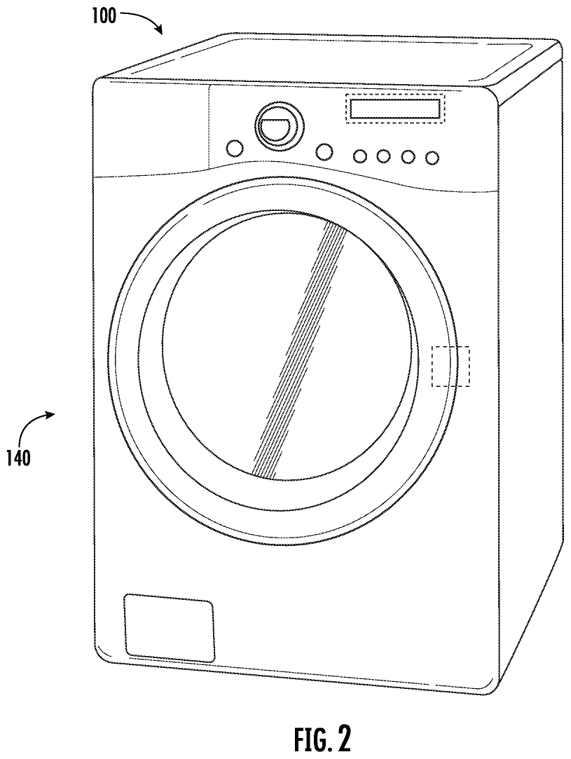

As part of the commissioning process, embodiments of the present disclosure may use image analysis, processing, and artificial intelligence. According to exemplary embodiments of the present subject matter, obtaining one or more images of a household appliance may be captured for analysis. Although the term “image” is used herein, it should be appreciated that according to exemplary embodiments, images may be captured by external device 172, which may take any suitable number or sequence of two-dimensional images, videos, or other visual representations (e.g., image 140, FIG. 2) of a household appliance in preparation for commissioning. For example, the one or more images may include a video feed or series of sequential static images obtained by a camera assembly included in the external device 172 and that may be transmitted to the network 174 (e.g., as a data signal) for analysis or other manipulation. These obtained images may vary in number, frequency, angle, field-of-view, resolution, detail, etc.

The present disclosure may include analyzing the one or more images 140 to identify the household appliance 100 with specificity, for example model name or number, range of serial numbers for the appliance, or other information that may be used in the network to identify the household appliance 100. According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm in the analysis of the captured image 140. This image analysis or processing may be performed remotely at a remote server or network 174 which may store a library of household appliance images to facilitate identification of newly submitted images.

Specifically, the analysis of the one or more captured images 140 may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of captured image 140 with images stored in the network 174. This comparison may help identify substantial similarities in the captured 140 and stored images, e.g., to identify the captured image 140. For example, one or more reference images may be obtained when a new product is released, and these references images may be stored in the network 174 for future comparison with images captured in anticipation of commissioning.

According to exemplary embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine (e.g., executed at the network 174 based on one or more stored images). Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate image identification, avoid erroneous appliance identification, and isolate the important object within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate identification of a household appliance in a captured image. According to exemplary embodiments, any suitable number and combination of image processing, image recognition, or other image analysis techniques may be used to obtain an accurate analysis of the captured images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the conv5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, appliance recognition and identification. Indeed, the methods described herein may use any or all of these techniques interchangeably to improve image analysis process and facilitate improved appliance recognition and identification. The image processing algorithms and machine learning image recognition processes described herein are only exemplary and are not intended to limit the scope of the present subject matter in any manner.

When commissioning a household appliance to a remote network, typically a secured network, establishing a connection typically requires, for example, authentication for access to the network. Commissioning the appliance for the first time, the appliance is placed in a conditioning for commissioning (for example through manipulation of the input selectors 162) and then an access point is provided with a network identification and password for connection to the secure network. To facilitate the secure connection, the appliance typically includes access point information, such as the required network identification and password, to allow the appliance to connect to the network via the access point, which may be a part of a WI-FI® network, e.g., in a user's home or may be provided in the household appliance 100. The access point information on the appliance is typically hidden from general view but still located in an easily accessible area that is selected to maintain the visual integrity of the information, that is the information is protected from abrasion, fading, or other conditions that may make the information illegible over time.

To assist a user in locating the access point information, the present disclosure is directed to capturing an image of the appliance to be received at the network 174 to identify the appliance. For example, the image 140 (one or more still images or videos) may contain sufficient accuracy and contains sufficient identifying features of the appliance 100 to identify the appliance, for example to determine the model number or serial number of the appliance 100. For example, an adequate captured image 140 illustrated in FIG. 2 may provide sufficient visual identifying features (for example, shape of the appliance; number, shape, and location of controls; contour of the door; etc.) for an image processing application to identify the appliance 100 with specificity. As discussed above image analysis, processing, and artificial intelligence (AI) may be used in comparing the captured image 140 to previously stored and identified images in the network 174 to facilitate accurate identification of the household appliance captured in image 140.

The captured image 140 may be captured by external device 172, which may be any device configured to capture an image and transmit it to network 174. <<Inventors: please confirm that initial image is transmitted via external device (i.e., cell phone, tablet, etc.) over the standard network the device uses. The home network and the appliance are not involved in this transmission.>> Once the captured image 140 is received at network 174, it is processed using one of the image processing techniques described above to facilitate the comparison to the stored images. The processed image is compared to the images in the library of household appliances stored in the network 174 to match with the captured image 140, thereby identifying the household appliance 100 in the captured image 140.

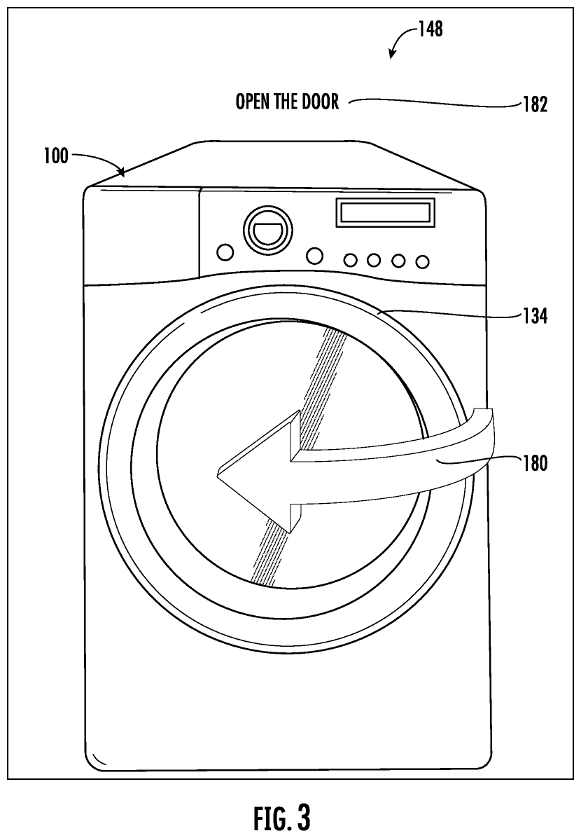

Once the appliance 100 in the captured image 140 is identified, the network 174 determines the location of the access point information on the appliance 100. The network 174, or processors in the network, can generate and transmit guidance to the external device 172 to locate the access point information. <<Inventors: please confirm transmission of the guidance to the external device.>> As illustrated in FIG. 3, the guidance may be a guidance image 148, or a series of guidance images 148, with visual instructions provided on a display device. For example, as illustrated in FIG. 3, guidance image 148 includes an arrow 180 that may indicate that the door 134 is to be open as a first step in locating the access point information. The graphical instructions may be accompanied by textural instructions 182. Multiple steps may be included in one guidance image 148.

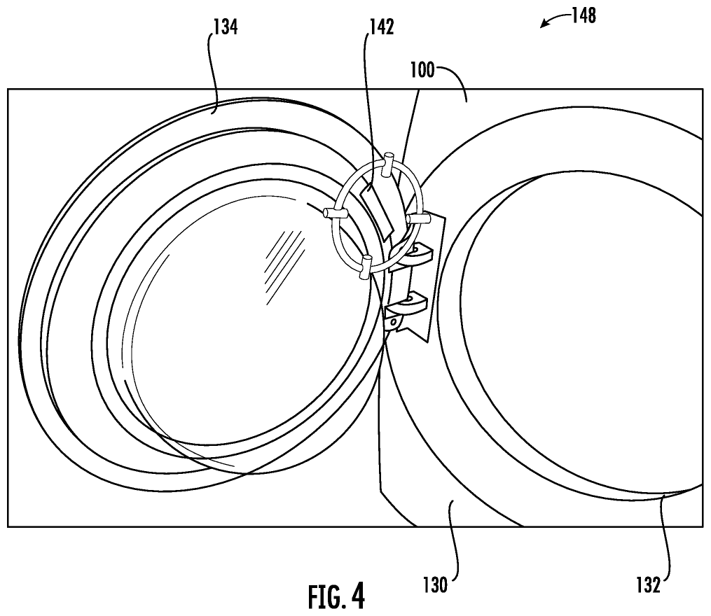

FIG. 4 is illustrative of a second guidance image 148 illustrating the result of successfully executing the guidance step as provided in FIG. 3. In FIG. 4, the door 134 is now open, uncovering the access point information 142 for the household appliance 100. In this illustrative example, the access point information 142 is affixed to a portion of the door 134 (e.g., as a label) that is hidden from view when the door is in a closed position a in FIG. 3. When followed, the guidance steps indicates the location of the access point information 142. To draw attention to the location, the image provided (as in FIG. 4) may include a highlighted area in which to find the access point information 142. As illustrated, the information is encircled with details added to the circle to direct a viewer's attention to the desired area. In some embodiments, the user's attention may be directed to the access point information 142 in other, or additional ways. If a color image is provided, contrasting colors may be used to focus attention on the desired area. Animation, such as flashing graphics (e.g., arrows) may be included directing attention to the access point information.

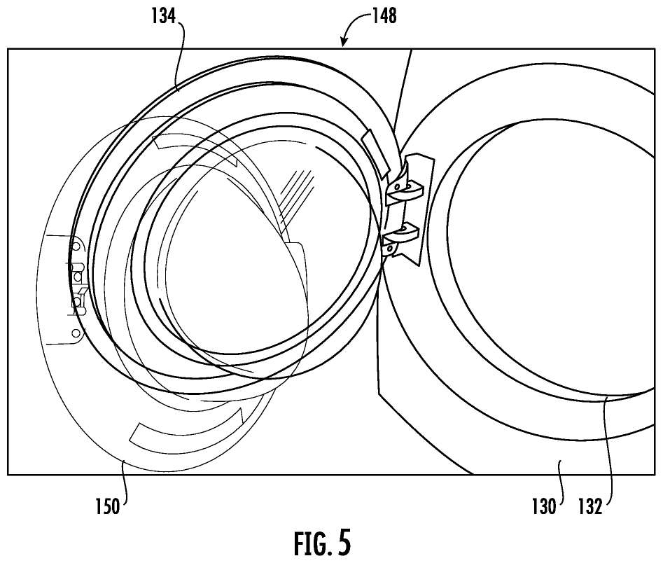

In another embodiment as illustrated in FIG. 5, a computer-generated overlay 150 may be provided in the guidance image 148 to facilitate locating the access point information 142. The illustrated overlay 150, representative of a computer aided drawing (CAD) of an interior portion of the door 134 is provided, and may be movable with respect to the actual image. The access point information 142 may be provided on the overlay 150 and highlighted as described above. In other embodiments, the overlay 150 may be movable to align with the actual appliance part (as illustrated door 134) in the guidance image 148 and the combination of image and overlay may trigger a confirmatory display indicating the location of the access point information 142.

In some embodiments, the guidance image 148 may include only drawings representative of the household appliance 100 using visual cues to highlight the area of interest to the user, for example the location of the access point information 142. In other embodiments, the guidance image 148 may include only photographs or photo-realistic images of the household appliance 100. In still other embodiments, a combination of photographs/photo-realistic images and drawings may be used in the guidance images 148.

In an aspect of the present disclosure, the access point information 142 provided on the appliance 100 may be provided to the network 174 in an image, for example an image captured by external device 172 and communicated to the network 174. <<Inventors: Please confirm the image for OCR processing is also transmitted by the external device using the standard network used by the device.>> According to the present disclosure, an image of the access point information 142 received by the network 174 may be processed using optical character recognition (OCR) techniques. As generally understood, OCR, in the field of pattern recognition, is the conversion of text (e.g., text that has been handwritten, printed, photographed, scanned, etc.) into machine-encoded text that can be, among other things, electronically recognized and searched. The OCR system can, or can be trained to, recognize text captured in an image.

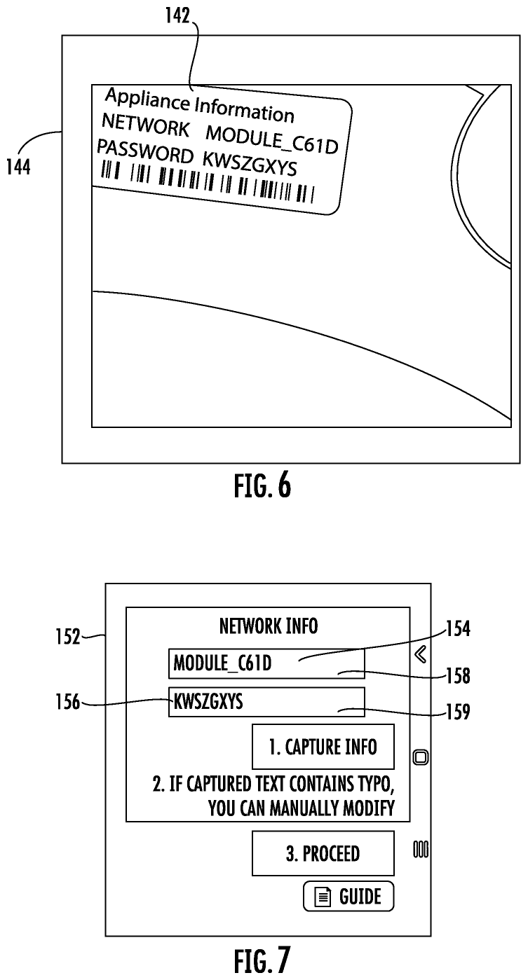

In the present disclosure, OCR may be used to analyze graphical patterns in a captured image of access point information 142 and recognize the patterns as, for example, a network identification and a password. FIG. 6 is representative of a captured image 144 of access point information 142 as received at network 174. From the captured image 144, OCR may be applied to recognize the network identification and password included in the access point information 142. Among other things, OCR may process or analyze the captured image 144 to recognize graphic symbols or characters in the image 144 as text. OCR, alone or with other applications in the network 174, may then analyze the identified text to determine and extract the desired network identification and password.

The determination may be based on context and pattern recognition. For example, the OCR may examine character strings in the access point information 142 and determine which strings are of interest, i.e., which string may be the network identification and which may be the password. The strings may have been analyzed based on context and pattern of the recognized characters. For example, the OCR may recognize network identification strings as beginning with a certain character or characters, having a certain number or type of characters (type being alphabetic, numeric, symbolic, or the like), or having certain punctuation. The OCR may use a similar identification method to recognize the string of characters representing the password.

FIG. 7 is an exemplary representation 152 of an OCR analysis of the access point information 142 of captured image 144 in FIG. 6. Based on character recognition, the OCR identified two strings of characters that may have been the network identification and password of interest. The OCR may then have used context and pattern recognition to identify which string may corresponds to the network identification and which may correspond to the password. Based on the above methodology, or additional or alternative methodologies, the OCR identified character string 154 as the network identification and character string 156 as the password. As illustrated in FIG. 7, the OCR populated data fields 158, 159, corresponding to the network identification and the password, with the identified character strings. The data fields 158, 159 are provided by the network 174 to the external device 172. The data entered in the fields 158, 159 is extracted by the network 174 and used to validate the request for a secure communication link between the network and the appliance 100. <<Inventors: Please confirm this process.>>

According to embodiments of the present disclosure, the user has the opportunity to confirm that the captured image 144 of access point information 142 and entered into data fields 158, 159 accurately represent the access point information prior to submitting the access point information 142 to the network 174. If errors exist in the information entered, the user has an opportunity to capture an image of the access point information again, or to manually correct the data entered into the data fields 158, 159. Recapturing the image may be limited to a predetermined number of attempts before the network identification and password must be entered manually. Upon successful entering of the network identification and password in data fields 158, 159, respectively, the information is communicated to the network 174 to establish secure communication link 173 between the household appliance 100 and the network 174. Through secure communication link 173, the household appliance may be commissioned to the network in a network account according to established protocols.

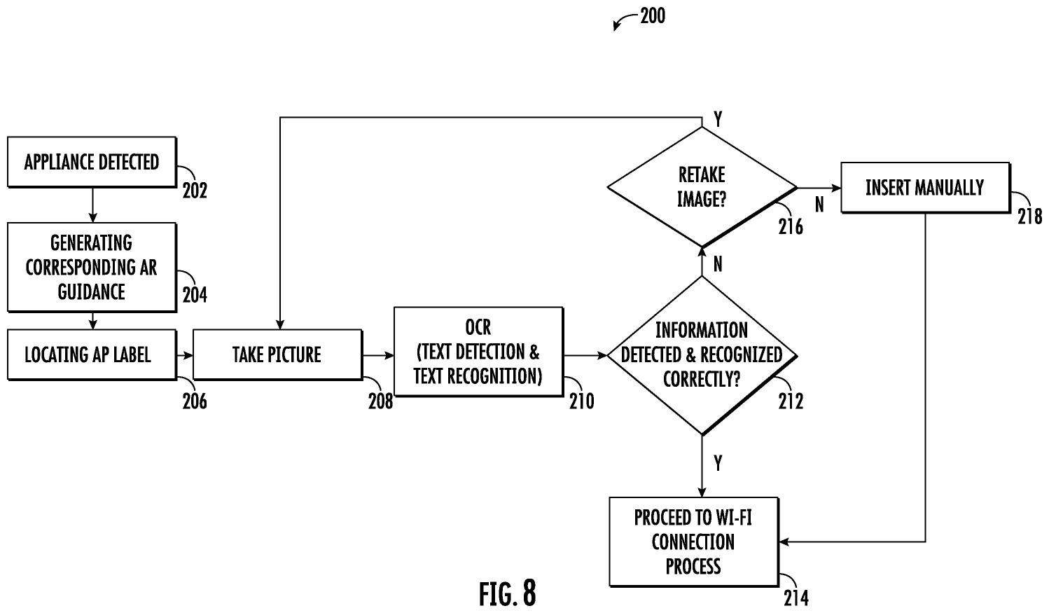

Now that the construction of a household appliance for commissioning in accordance with this disclosure has been presented, an exemplary method 200 of operation for an automated access point processing will be described with reference to FIG. 8. The access point information may include network identification and password information helpful or required for commissioning of the appliance. Method 200 begins at 202 with the detection of a household appliance for commissioning. The detection consists of receipt, at the network 174, and processing of a captured image 140 of the appliance 100 to be commissioned. Processing the image may extract identifying features of the appliance to facilitate identification. From the captured image 140, from the various image processing and analysis discussed above, the household appliance to be commissioned is detected with specificity. The network 174 includes necessary information on the household appliances that are suitable for commissioning using the disclosed method. Among the information at the network 174 is the location of the access point information for included appliances.

At 204, the network 174 generates visual instruction guidance to the location of the access point information. The visual guidance may include an augmented reality (AR) display in addition to, or instead of, an image of the appliance to be commissioned. If in addition to the image, the AG display may include graphics superimposed on a portion of the image to provide guidance. The visual guidance, with or without AG, may be provided to a display 164 on the appliance 100 or may be provided to an external device 172 for display to a user. The guidance may include a representative image of the appliance to be commissioned and animated graphics or other display to indicate the location on the appliance of the required access point information.

Upon following the guidance of 204, the access point information location may be located. In some instances the access point information is found on a label applied to a portion of the appliance 100. In other instances, the access point information is indicated (for example by printing, stamping, etching, or other durable markings) directly on a portion of the appliance.

In some disclosed embodiments, the method continues to 208 in which an image is captured of the access point information located in 206. The image 144 of the access point information may be captured by external device 172, or another suitable device for capturing and transmitting images or videos, and is received at the network 174 for processing.

The processing is carried out at 210 using at least optical character recognition (OCR) at the network 174. As described above, the OCR detects the text included in the image 144 of the access point information and extracts the required information. For example, the network identification and password required for commissioning may be identified using context and pattern recognition to identify which detected and recognized characters may corresponds to the network identification and which may correspond to the password. Once identified, the network identification and password can be extracted from the access point information.

At 212 according to embodiments of this disclosure, the graphic characters identified as the network identification and password may be populated in data fields 158, 159, respectively, and displayed to a user for confirmation. The display may be on the display 164 on the appliance 100 or may be on the external device 172. At this point, the user can confirm the accuracy of the detected characters and the method proceeds to 214 in which a secured communication link 173 is opened between the network 174 and the appliance 100 for commissioning.

At 212, the user may recognize an inaccuracy in the characters identified as the network identification and password and displayed in in data fields 158, 159. If an inaccuracy is noted at 212, the user is presented with the option to retake or recapture the image at 216. If this option is selected, the method returns to 208 at which an image of the access point information is captured. The method continues as above. This option, to recapture an image of access point information previously inaccurately captured may be available for a predetermined number of attempts. If the predetermined number of attempts is exceeded, the method reverts to manual input of the access point information.

At 216, if the option to recapture the image 144 is not chosen (or the number of attempts exceeds the predetermined number), the method steps to 218 reverts to manual entry of the access point information. Upon manual entry, the method advances to 214 at which a secured communication link 173 is opened between the network 174 and the appliance 100 for commissioning.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method of commissioning a household appliance, the method comprising:
receiving an image of the household appliance from an external device;
determining a location of an access point information based on the processing of the image;
generating guidance to the location of the access point information, wherein the guidance includes visual instructions provided on a display;
opening communication between the household appliance and a remote network using the access point information; and
commissioning the household appliance to a user account on the remote network.

2. The method of claim 1, wherein the image received includes one or more identifying features of the appliance.

3. The method of claim 2, wherein the image is one of a single still image, a series of multiple still images, and a video.

4. The method of claim 2, further comprising processing the image of the household appliance, wherein processing the image comprises extracting the one or more identifying features of the household appliance to facilitate identification of the household appliance.

5. The method of claim 1, wherein generating guidance includes an augmented reality display.

6. The method of claim 5, wherein the augmented reality display is provided on an external device.

7. The method of claim 5, wherein the augmented reality display includes an image of a household appliance representing the household appliance to be commissioned and animated graphics indicating the location of an access point location on the household appliance to be commissioned.

8. The method of claim 7, wherein the augmented reality display includes a graphic superimposed over a portion of the image of the household appliance representing the household appliance to be commissioned.

9. The method of claim 5, wherein the augmented reality display comprises a drawing of a portion of the household appliance identifying the access point location on the household appliance to be commissioned.

10. The method of claim 1, wherein the access point information comprises a network identification and a password.

11. The method of claim 1, wherein, after generating guidance to the location of the access point information, the method further comprises:
receiving an image of the access point information at a remote network from the external device;
processing the image;
detecting graphical characters in the processed image corresponding to a network identification and a password using optical character recognition; and
recognizing the network identification and the password, using optical character recognition.

12. The method of claim 11, wherein processing the image includes image analysis to identify graphical symbols for network identification and image analysis to identify graphical symbols for a password to gain access to the identified network.

13. The method of claim 12, wherein the image analysis to identify graphical symbols for network identification includes identifying a context of the graphical symbols of the network identification.

14. The method of claim 12, wherein the image analysis to identify graphical symbols for the password includes identifying a context of the graphical symbols of the password.

15. The method of claim 12, wherein the image of the access point information is one of a single still image, a series of multiple still images, and a video.

16. A method of commissioning a household appliance, the method comprising:
receiving a first image of the household appliance;
processing the first image of the household appliance, the processing including extracting one or more identifying features of the household appliance to facilitate identification of the household appliance;
determining a location of access point information based on the identification of the household appliance in the first image;
generating guidance to the location of the access point information, wherein the guidance includes visual instructions provided on a display;
receiving a second image, the second image including access point information;
processing the second image;
detecting graphical characters in the processed second image corresponding to a network identification and a password using optical character recognition;
recognizing the network identification and the password, using optical character recognition;
receiving the recognized network identification and password at a remote network;
opening communication between the household appliance and the remote network using the recognized network identification and password; and
commissioning the household appliance to a user account on the remote network.

17. The method of claim 16, wherein the communication between the household appliance and the remote network is facilitated by a local area network.

18. The method of claim 16, wherein the first and second images are received from an external device.

19. The method of claim 16, wherein the access point information includes a network identification and a password.

20. A method of commissioning a household appliance, the method comprising:
capturing an image of the appliance using an external device;
transmitting the image of the appliance from the external device to a network;
receiving guidance from the network to a location of an access point information;
capturing an image of the access point information at the location of the access point information; and
transmitting the image of the access point information to the network.
